(19) United States
(12) Patent Application Publication
(10) Pub. No.: US 2025/0203262 A1
(43) Pub. Date: Jun. 19, 2025

(54) EAR-WEARABLE DEVICE INCLUDING FILTER

(71) Applicant: Starkey Laboratories, Inc., Eden Prairie, MN (US)

(72) Inventors: Viktor Klymko, Minneapolis, MN (US); Dustin Degen, Waconia, MN (US); Jundong Li, Eden Prairie, MN (US)

(21) Appl. No.: 18/979,862

(22) Filed: Dec. 13, 2024

Related U.S. Application Data
(60) Provisional application No. 63/610,515, filed on Dec. 15, 2023.

(51) Int. Cl. H04R 1/08; H04R 1/10

(52) U.S. Cl. CPC H04R 1/086; H04R 1/1016; H04R 1/1033; H04R 2410/07

(57) ABSTRACT

Various embodiments of an ear-wearable device are disclosed. The device includes a housing, a microphone port disposed in the housing and extending between an inlet disposed at an outer surface of the housing and an outlet disposed within the housing, and a microphone disposed within the housing and acoustically coupled to the outlet of the microphone port. The device further includes a filter disposed over the inlet of the microphone port or at least partially within the microphone port, where the filter includes an open cell material.

### CROSS REFERENCE TO RELATED APPLICATIONS

This application claims the benefit of 63/610,515, filed Dec. 15, 2023, the disclosure of which is incorporated by reference herein in its entirety.

### BACKGROUND

Ear-wearable devices such as hearing devices are disposed in an ear of a wearer or inserted into an opening of an ear canal of the wearer and typically include a housing or shell with electronic components such as a receiver (i.e., speaker) disposed within the housing. The receiver is adapted to provide acoustic information in the form of sound waves to the wearer's ear canal from a controller either disposed within the housing of the hearing device or connected to the hearing device by a wired or wireless connection. This acoustic information can include music or speech from a recording or other source. For ear-wearable devices such as hearing devices (e.g., hearing assistance devices), the acoustic information provided to the wearer can include ambient sounds such as speech from a person or persons that are speaking in proximity to the wearer. Such speech can be amplified so that the wearer can better hear the speaker.

Hearing assistance devices, such as hearing aids, can be used to assist wearers suffering hearing loss by amplifying sounds into one or both ear canals. Such devices typically include hearing assistance components such as a microphone for receiving ambient sound, an amplifier for amplifying the microphone signal in a manner that depends upon the frequency and amplitude of the microphone signal, a speaker or receiver for converting the amplified microphone signal to sound for the wearer, and a battery for powering the components.

### SUMMARY

In general, the present disclosure provides various embodiments of an ear-wearable device. The device can include a filter disposed over an inlet of a microphone port of the device or at least partially within the microphone port. Such filter can reduce turbulence and pressure variations in the microphone port caused by the wind to a negligible level, thereby substantially eliminating wind noise in a signal provided by a microphone of the device. A filter can also be disposed over an outlet of an acoustic port of the device or at least partially within the acoustic port, where the acoustic port acoustically couples a receiver (i.e., speaker) disposed within the housing of the device to the outlet of the acoustic port. The acoustic port filter and microphone port filter can help prevent ingress of debris such as wax into their respective ports. Wax can at least partially occlude at least one of the acoustic port or microphone port and attenuate sound waves generated by the receiver and directed to an ear of a wearer through the acoustic port or sound waves from the wearer's environment directed to the microphone through the microphone port.

In one aspect, the present disclosure provides an ear-wearable device including a housing, a microphone port disposed in the housing and extending between an inlet disposed at an outer surface of the housing and an outlet disposed within the housing, and a microphone disposed within the housing and acoustically coupled to the outlet of the microphone port. The device further includes a filter disposed over the inlet of the microphone port or at least partially within the microphone port, where the filter includes an open cell material.

In another aspect, the present disclosure provides a method including acoustically coupling, via an inlet of a microphone port, air outside of a housing of an ear-wearable device with an outlet of the microphone port within the housing; disposing a filter over the inlet of the microphone port or at least partially within the microphone port, where the filter includes an open cell material; and acoustically coupling a microphone with the outlet of the microphone port. The method further includes using signals from the microphone to reproduce sound into an ear canal of a wearer of the ear-wearable device.

In another aspect, the present disclosure provides an ear-wearable device including a housing, a receiver disposed at least partially within the housing and configured to direct sound waves into a wearer's ear through an acoustic port that extends between an outlet disposed on an outer surface of the housing and an inlet disposed within the housing that is acoustically coupled to the receiver, and a filter disposed over the outlet of the acoustic port or at least partially within the acoustic port, where the filter includes an open cell material.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of an ear-wearable device.

FIG. 2 is a schematic top perspective view of a portion of a housing of the wear-wearable device of FIG. 1.

FIG. 3 is a schematic cross-section view of the housing of the hearing device of FIG. 1.

FIG. 4 is a schematic cross-section view of an earpiece housing of an earpiece of the device of FIG. 1.

FIG. 5 is a schematic cross-section view of one embodiment of a filter that can be utilized with the ear-wearable device of FIG. 1.

FIG. 6 is a schematic cross-section view of a housing of another embodiment of an ear-wearable device.

FIG. 7 is a schematic cross-section view of another embodiment of an ear-wearable device.

FIG. 8 is a flowchart of one embodiment of a method of manufacturing the ear-wearable device of FIG. 1.

FIG. 9 is a graph of averaged Fourier amplitude versus frequency for a simulated ear-wearable device.

FIG. 10 is a schematic diagram of another embodiment of an ear-wearable device.

FIGS. 11A-C are various schematic views of an embodiment of first and second filters that can be utilized with the ear-wearable device of FIG. 1, where FIG. 11A illustrates schematic cross-section views of the first and second filters, FIG. 11B illustrates schematic plan views of the first and second filters, and FIG. 11C illustrates schematic magnified views of a portion of each of the first and second filters.

### DETAILED DESCRIPTION

In general, the present disclosure provides various embodiments of an ear-wearable device. The device can include a filter disposed over an inlet of a microphone port of the device or at least partially within the microphone port. Such filter can reduce turbulence and pressure variations in the microphone port caused by the wind to a negligible level, thereby substantially eliminating wind noise in a signal provided by a microphone of the device. A filter can also be disposed over an outlet of an acoustic port of the device or at least partially within the acoustic port, where the acoustic port acoustically couples a receiver (i.e., speaker) disposed within the housing of the device to the outlet of the acoustic port. The acoustic port filter and microphone port filter can help prevent ingress of debris such as wax into their respective ports. Wax can at least partially occlude at least one of the acoustic port or microphone port and attenuate sound waves generated by the receiver and directed to an ear of a wearer through the acoustic port or sound waves from the wearer's environment directed to the microphone through the microphone port.

An acoustic path (i.e., microphone port) of a microphone of an ear-wearable device can suffer from foreign material ingress, which can eventually degrade performance of the microphone and in turn the device. Also, an acoustic port of a receiver can be at least partially occluded by foreign material or debris, thereby attenuating sound waves that are directed from the receiver through the acoustic port to an ear of a wearer. As a result of these occlusions, such device needs to be cleaned, which often requires expensive shipping and professional service.

Additionally, all microphones can be subjected to wind noise in an open environment, and sensitive microphones combined with high gain amplification in hearing devices such as hearing aids can be especially vulnerable to such wind noise. In subjective testing and acoustic measurements, some microphones have exhibited susceptibility to wind noise, even when separated from the wind by an elongated microphone port. This susceptibility can be location specific, e.g., a microphone at one end of the hearing device may be more susceptible than the same type of microphone at another location within the same device. Simulations have shown that steady wind flow causes ultrasonic resonance along the microphone port. The ultrasonic peak effectively increases microphone sensitivity in this frequency range. This can also make the hearing device sensitive to noise generated by other ultrasonic acoustic field sources such as motion detectors. Any potential solutions to this problem are limited by the small volume of the microphone port and should remain acoustically transparent within a functional bandwidth of the device.

One or more embodiments of ear-wearable devices described herein can provide various advantages over known devices. For example, one or more filters can be disposed over or at least partially within a microphone port that can reduce or eliminate wind noise received by the microphone of the device. Further, one or more filters disposed over or at least partially within a port of the device can prevent ingress of debris into such port.

Any suitable material can be used for these filters. In one or more embodiments, the filter can include an open cell material. As used herein, the term “open cell material” may refer to quasi-periodic three-dimensional structures that include cells or voids interlaced with regions of solid material. The cells of the “open cell material” may be in fluid communication with each other and an external environment such that the cells may be filled with matter of any environmental medium in which the “open cell material” may reside such as, for example, air. Such open cell material can include, e.g., melamine or polyurethane. In one or more embodiments, the open cell material of the filter can define an irregular internal structure of the filter, were the irregular internal structure is predefined. Such filters can be manufactured using any suitable techniques, e.g., 3D printing, additive manufacturing, laser etching of a monolithic substrate, laser etching of a layered substrate, etc.

In one or more embodiments, the open cell material of the filter can reduce turbulence and pressure variations in the microphone port caused by the wind to a negligible level, thereby substantially eliminating wind noise in a signal provided by the microphone. Further, the filter can be configured to block ear wax and other ingress material or debris from entering a port of the device. In one or more embodiments, the filter can be removed from the port once the filter's cells are filled with ingress material.

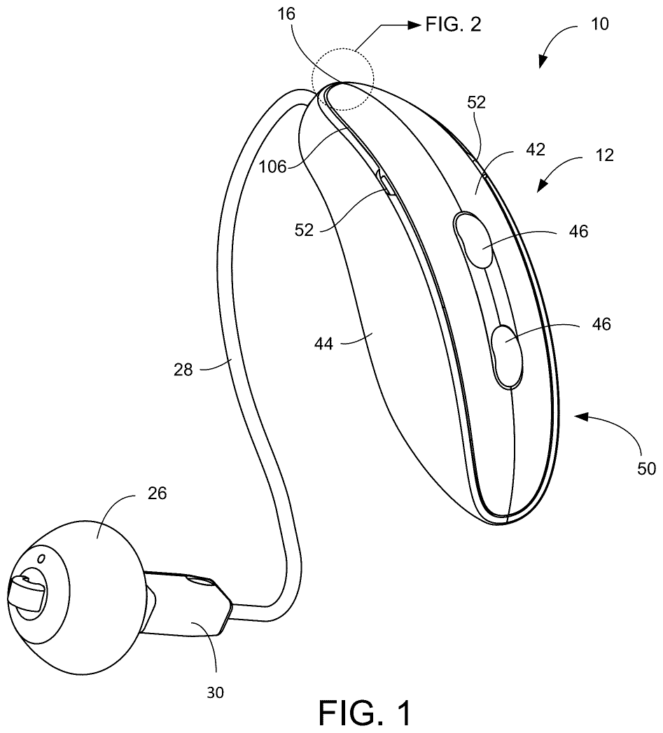

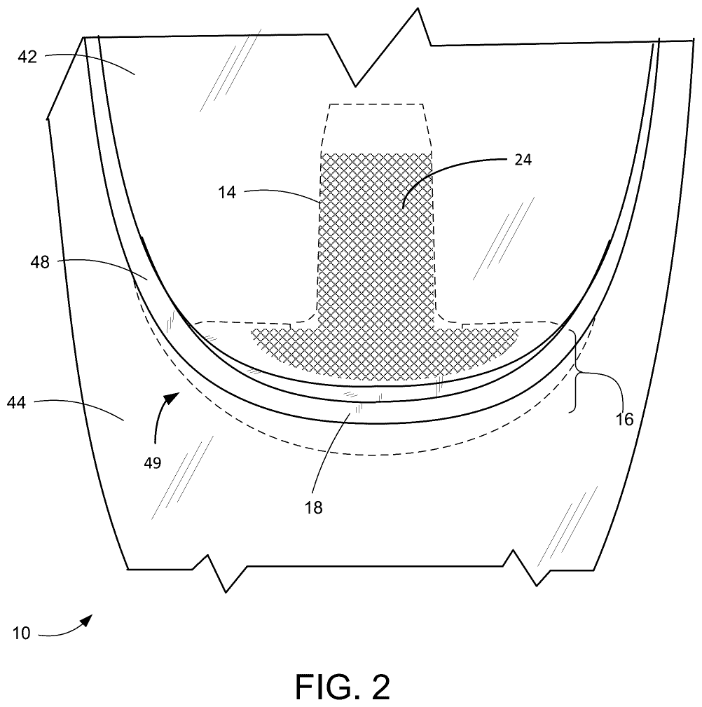

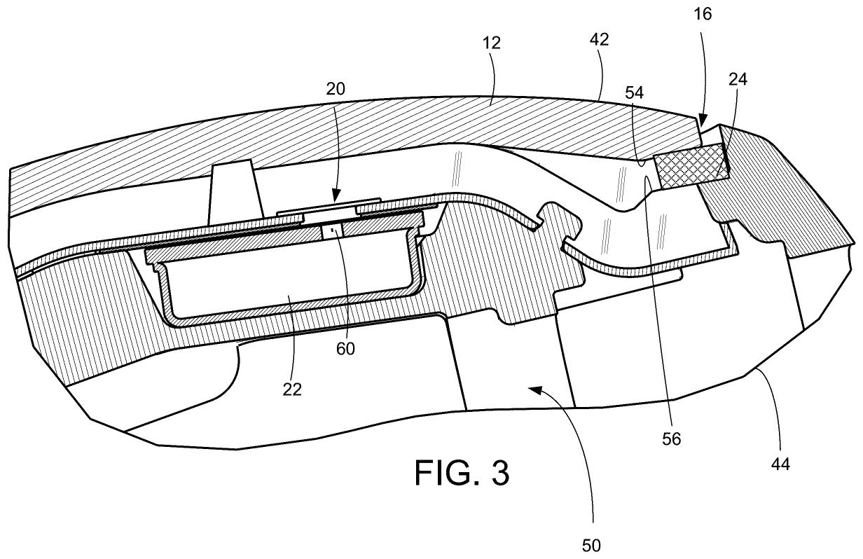

FIGS. 1-4 are various views of one embodiment of an ear-wearable device 10. The illustrated embodiment of the device 10 is a behind-the-ear (BTE) type device and thus includes a housing 12 that is operable to be worn on or behind an ear of a wearer. The device 10 further includes a microphone port or acoustic pathway 14 (FIGS. 2-3) disposed in the housing 12 and extending between an inlet 16 disposed at an outer surface 18 of the housing and an outlet 20 disposed within the housing. The device 10 further includes a microphone 22 disposed within the housing 12 and acoustically coupled to the outlet 20 of the microphone port. Additionally, a filter 24 is disposed over the inlet 16 of the microphone port 14 or at least partially within the microphone port. In one or more embodiments, the filter 24 includes an open cell material.

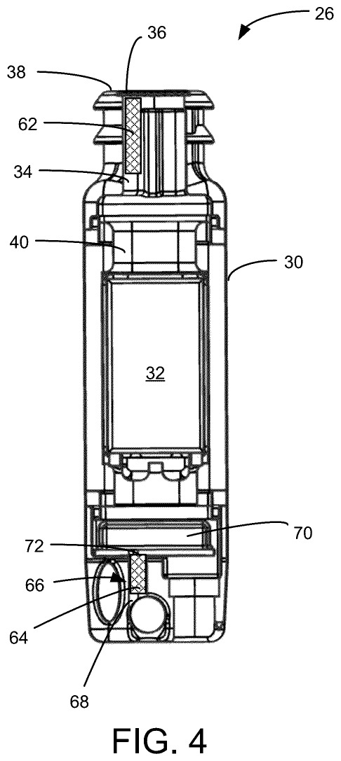

The device 10 can also include an earpiece 26 that is coupled to the housing 12 by a cable 28. The earpiece 26 can include an earpiece housing 30 and a receiver 32 (FIG. 4) disposed at least partially within the housing. The receiver 32 is configured to direct sound waves into the wearer's ear through an acoustic port 34 that extends between an outlet 36 of the port disposed at an outer surface 38 of the earpiece housing 30 and an inlet 40 of the port disposed within the earpiece housing that is acoustically coupled to the receiver.

The device 10 can include any suitable ear-wearable device, e.g., one or more of the embodiments of ear-wearable devices described in U.S. Provisional Application No. 63/534,922, filed Aug. 28, 2023, and entitled EAR-WEARABLE DEVICE WITH MICROPHONE INLET DIVIDER. In one or more embodiments, the ear-wearable device 10 can be a hearing device such as a hearing assistance device. Any suitable hearing assistance device can be utilized, e.g., behind-the-ear (BTE), in-the-ear (ITE), in-the-canal (ITC), receiver-in-canal (RIC), completely-in-the-canal (CIC), or invisible-in-the-canal (IIC)-type hearing assistance devices. In one or more embodiments, the device 10 is configured to be disposed at least partially within the ear canal of the wearer such as a CIC or IIC device. It is understood that BTE type hearing devices can include devices that reside substantially behind the ear or over the ear. Such devices can include hearing devices with receivers associated with an electronics portion of the device or hearing devices of the type having receivers in the ear canal of the wearer, including but not limited to receiver-in-canal (RIC) or receiver-in-the-ear (RITE) designs. The present subject matter can also be used in hearing assistance devices generally, such as cochlear implant type ear-wearable devices and such as deep insertion devices having a transducer, such as a receiver or microphone, whether custom fitted, standard, open fitted, or occlusive fitted. The present subject matter can additionally be used in consumer electronic wearable audio devices having various functionalities. It is understood that other devices not expressly stated herein can also be used with the present subject matter.

The housing 12 of the ear-wearable device 10 is configured to rest against the wearer's outer ear in a behind-the-ear orientation. The housing 12 can be manufactured using any suitable technique, e.g., injection-molding, 3D printing, etc. Further, the housing 12 may be formed using any suitable material, e.g., at least one of silicone, urethane, acrylate, flexible epoxy, or acrylated urethane. The embodiment illustrated in FIGS. 1-3 includes a top shell 42 and a bottom shell 44 that forms the housing 12. In one or more embodiments, the top shell 42 is removably attached to the bottom shell 44 by utilizing any suitable technique, e.g., adhering, snap fitting, press fitting, mechanically fastening, or the like.

For purposes of this disclosure, the terms “top,” “bottom,” “above,” “below,” “front,” “back,” etc., when referencing the shells 42, 44 and other parts of the device 10, are not intended to indicate a required orientation of use relative to the ground or other reference point. Generally, these terms are intended to help distinguish locations relative to an arbitrary reference point and may correspond to the orientation in the drawings, but no limitation is intended by the use of these terms.

The top and bottom shells 42, 44 form an enclosure 50 that, once assembled, holds electronic components such as the microphone 22. A groove 48 (FIG. 2) is defined by an interface between the assembled top and bottom shells 42, 44. In this example, the groove 48 extends around a periphery 49 of the top shell 42 and bottom shell 44. The groove 48 provides locations in which ports, inlets, and the like can be placed for allowing air to enter within the housing 12.

The housing 12 includes at least one microphone inlet 16 that forms part of the microphone port 14 from the outside of the housing 12 (FIG. 3) to inside of the housing. In one or more embodiments, the groove 48 need not extend along the periphery 49 of the shells 42, 44, e.g., may be a slot, port, gap, or other feature that allows air to flow between the shells proximate the microphone inlet 16. The microphone inlet 16 along with the microphone port 14 provide an air passageway from the ambient environment to within the housing 12.

Additional microphone inlets can be disposed in the housing 12 for additional microphones, as indicated by microphone inlets 52 (FIG. 1), which are sometimes referred to as rear microphone inlets that acoustically couple outside air to a rear microphone (not shown). In such an arrangement, at least one of the microphone inlets 52 may be referred to as a front microphone inlet and acoustically couples outside air to a front microphone (e.g., microphone 22 in FIG. 3). Further, the groove 48 that is coupled to multiple microphone inlets 52 may be implemented as two or more separate slots, ports, or the like that are individually located over the inlets 16, 52 instead of being a continuous, peripheral, groove as shown.

The microphone port 14 is disposed within the housing 12 and extends between the inlet 16 disposed at the outer surface 18 of the housing and the outlet 20 disposed within the housing. The port 14 can take any suitable shape and have any dimensions. Further, the inlet 16 of the port 14 can take any suitable shape and have any suitable dimensions. In the illustrated embodiment, the inlet 16 is defined by a top surface 54 (FIG. 3) of the top shell 42 and a bottom surface 56 of the bottom shell 44. The inlet 16 of the microphone port 14 can be disposed in the top shell 42, the bottom shell 44, or in both the top and bottom shells. Air can flow between the outside of the housing 12 and into/out of the microphone port 14 via the inlet 16.

The microphone port 14 is designed to acoustically couple sound from outside the ear-wearable device 10 to the microphone 22 disposed at least partially within the device through the outlet 20 that is acoustically coupled to the microphones. The microphone 22 can be disposed at least partially within the housing 12 in any suitable location such that it is acoustically coupled to the outlet 20 of the microphone port 14. As used herein, the term “acoustically coupled” means that sound waves entering the microphone port 14 from the ambient environment can be directed by the microphone port 14 into an inlet 60 of the microphone 22 such that the microphone can detect these sound waves. The microphone 22 can include any suitable microphone or array of microphones. In one or more embodiments, the microphone 22 is configured to provide one or more signals that are configured to reproduce sound into the ear canal of the wearer utilizing, e.g., a receiver that can be disposed within the housing 12 as is further described herein.

Disposed over the inlet 16 of the microphone port 14 or at least partially within the microphone port 14 is the filter 24. In general, the filter 24 can be configured to reduce wind noise received by the microphone 22 through the microphone port 14 using any suitable technique. Further, the filter 24 can be configured to at least partially block ingress of debris into the microphone port 14.

The filter 24 can take any suitable shape and have any suitable dimensions. Further, the filter 24 can be disposed in any suitable relationship relative to the microphone port 14. As shown in FIG. 2, the filter 24 is disposed at least partially within the microphone port 14. In one or more embodiments, the filter 24 can be disposed over the inlet 16. In one or more embodiments, the filter 24 can be disposed at least partially within the microphone port 14 or entirely within the microphone port. In one or more embodiments, the filter 24 can be disposed over the inlet 16 and at least partially within the microphone port 14. The filter 24 can at least partially occlude the inlet 16. Further, the filter 24 can at least partially occlude the microphone port 14. In one or more embodiments, the filter 24 completely occludes the inlet 16 such that any sound waves that are incident upon the inlet are also incident upon the filter 24. Further, in one or more embodiments, the filter 24 can completely occlude the microphone port 14. The filter 24, when disposed at least partially within the microphone port 14, can be disposed in any suitable portion of the port. As shown in FIG. 3, the filter 24 is disposed in the microphone port 14 adjacent to the inlet 16.

The filter 24 can include any suitable material. In one or more embodiments, the filter 24 includes an open cell material. Any suitable open cell material can be utilized for the filter 24, e.g., at least one of melamine, polyurethane, etc. In one or more embodiments, the open cell material of the filter 24 is a foam. In one or more embodiments, the open cell material can define an irregular internal structure that is predefined. The open cell material of the filter 24 can have any suitable physical characteristics. In one or more embodiments, the open cell material can have an average pore diameter of at least 80 μm and no greater than 200 μm. Further, the open cell material of the filter 24 can include a porosity of at least 90% and no greater than 99%.

The filter 24 can also include any suitable materials or structure that provide additional functionality. For example, in one or more embodiments, the filter 24 can include at least one of a hydrophobic material (e.g., a hydrophobic nano-coating) or an olcophobic material (e.g., an olcophobic silicate).

The filter 24 can exhibit a low acoustic impedance such that a substantial portion of sound waves (i.e., longitudinal waves) that are incident upon the filter at any suitable incident angle are transmitted therethrough to the microphone 22 via the microphone port 14. In one or more embodiments, the filter 24 is configured to attenuate sound waves received into the microphone port 14 by no greater than 4 dB SPL, no greater than 3 dB SPL, no greater than 2 dB SPL, or no greater than 1 dB SPL. In contrast, the filter 24 can be configured to reduce turbulence and pressure variations in the microphone port 14 caused by wind to a negligible level, thereby substantially eliminating wind noise in a signal provided by the microphone 22.

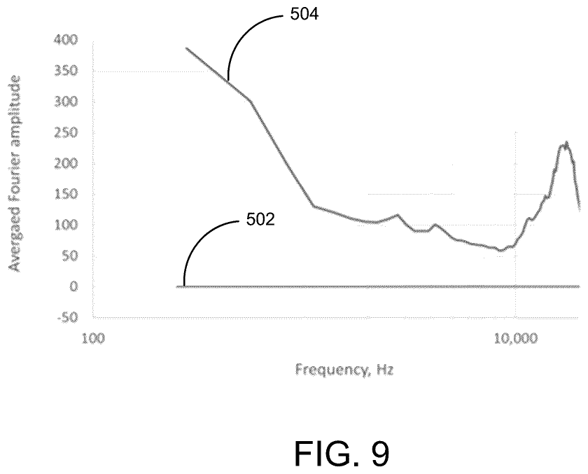

FIG. 9 is a graph that shows results of a fast Fourier transform (FFT) of simulated pressure at the microphone 22 for a similar design with a gust of wind incident upon the inlet 16 of the microphone port 14 at a substantially orthogonal direction to an axis of a plane of the inlet. Curve 502 represents a simulation where the device 10 includes a melamine foam filter 24 disposed within the microphone port 14, and curve 504 represents a simulation where the device does not include the filter. As can be seen in FIG. 9, the addition of the filter 24 reduced the wind noise perceived by the microphone 22 to negligible levels.

The filter 24 can be made using any suitable technique. In one or more embodiments, the filter 24 can be a foam filter that is formed using any suitable foaming technique. In one or more embodiments, the filter 24 can be a microstructured filter that is formed using any suitable technique, e.g., at least one of electrostatic deposition, electrostatic vacuum deposition, electrospinning, electrospraying, 3D printing, laser etching, etc.

In general, open cell materials can form or define an irregular internal structure that may effectively mitigate the transmission of turbulent and high velocity fluid movement such as, e.g., wind noise. However, typical open cell material formation, e.g., using a homogeneous polymer/gas mixture used to drive bubble nucleation and growth, may not result in a predefined or repeatable open cell structure as the formation and structure of each batch of typical open cell material is random. Accordingly, the acoustic loss across some filters formed from typical open cell materials may be inconsistent. In contrast, open cell materials as described herein can provide more consistent acoustic loss profiles from filter to filter by using formation methods that are repeatable and reproducible to provide an irregular internal structure that is predefined.

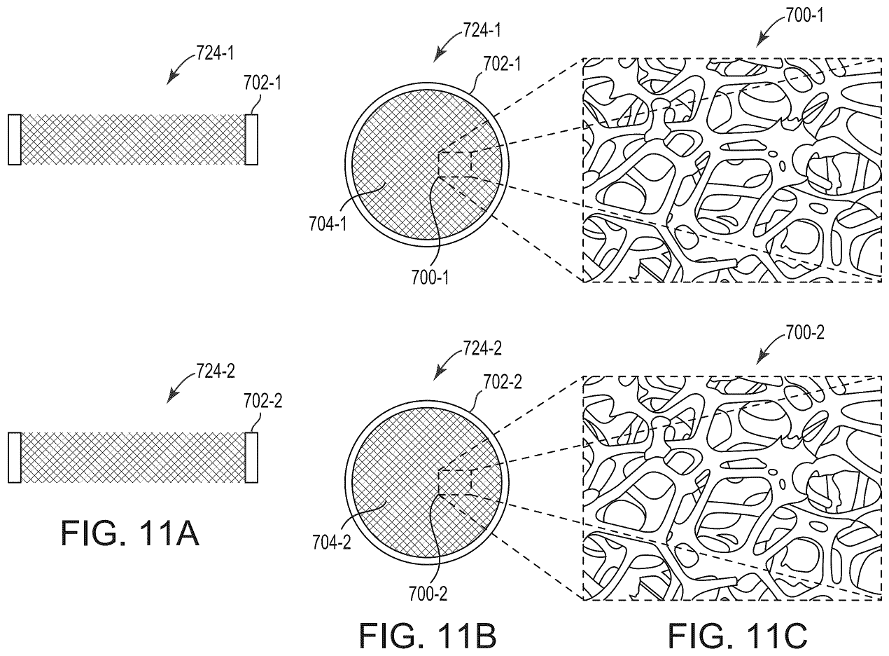

FIGS. 11A-C are various schematic views of an embodiment of a first filter 724-1 and a second filter 724-2 (collectively referred to as filters 724). The filters 724 can each include a frame 702-1 and 702-2 (collectively referred to as frames 702) respectively. The filters 724 can be connected to the frames 702 using any suitable technique. As shown, each filter 724 includes an open cell material. The magnified portions 700-1 and 700-2 (collectively referred to as magnified portions 700) of open cell material of each filter 724 as shown in FIG. 11C are representative of an irregular internal structure of the filter. The filters 724 can be manufactured using any suitable technique that can provide an open cell structure that is repeatable across multiple filters, e.g., 3D printing, additive manufacturing, laser etching of a monolithic substrate, laser etching of a layered substrate, etc. In one or more embodiments, the filters 724 can be manufactured using micro- or nano-fibers that are formed and then assembled, e.g., by attaching the fibers to the frame 702.

While the magnified portion 700-1 of the first filter 724-1 is substantially identical (within a given manufacturing tolerance) to the magnified portion 700-2 of the second filter 724-2 due to the predefined nature of the open cell material and its internal structure, such magnified portion of each filter 724 is substantially different from remaining portions 704-1 of the first filter 724-1 and remaining portions 704-2 of the second filter 724-2 respectively. In other words, the magnified portion 700 of each filter 724 is uniquely structured relative to other portions of each of their respective filters. As a result, the open cell material of each filter 724 can define an irregular internal structure of the filter, where the irregular internal structure is predefined. The consistency of predefined structures from filter to filter during the manufacturing process can provide more predictable acoustic properties for the filters. These structured filters 724 can exhibit a predetermined acoustic loss across each filter because of their consistent pore characteristics. While a pore size of a particular filter 724 can vary, the overall characteristics of the filter can be consistent.

In one or more embodiments, the filter 24 is made separately from the housing 12 and disposed over the inlet 16 or at least partially within the microphone port 14 using any suitable technique. In one or more embodiments, the filter 24 is friction-fit at least partially within the microphone port 14. Further, in one or more embodiments, the filter 24 can be adhered to the outer surface 18 of the housing 12 and/or the microphone port 14 using any suitable adhesive, e.g., a UV-cured epoxy adhesive. In one or more embodiments, the filter 24 can be mechanically attached to the outer surface 18 of the housing 12 using any suitable technique. In one or more embodiments, the filter 24 can form a portion of the housing 12. In one or more embodiments, the filter 24 can be disposed over the inlet 16 or at least partially within the microphone port 14 by casting the filter onto the housing 12 and curing the filter in place. In one or more embodiments, the filter 24 can be disposed (e.g., printed) over the inlet 16 or at least partially within the microphone port 14 using any suitable technique (e.g., electrostatic deposition, 3D printing, etc.) to form a microstructured filter.

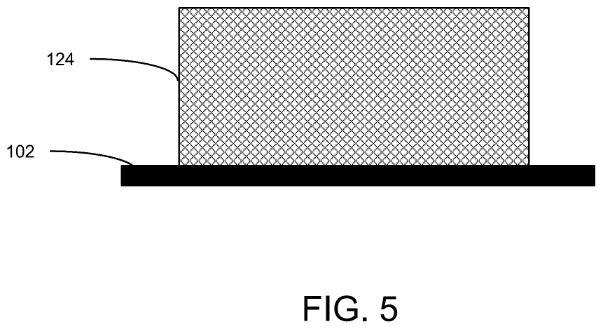

To assist with handling during assembly and removal for cleaning, the filter 24 can be connected to a frame or carrier. For example, FIG. 5 is a schematic cross-section view of another embodiment of a filter 124. All design considerations and possibilities described herein regarding the filter 24 of FIGS. 1-4 apply equally to filter 124 of FIG. 5. The filter 124 is connected to a frame 102 using any suitable technique, e.g., adhesive can be applied to at least one of the filter or the frame such that the filter can be attached to the frame. The frame 102 can include any suitable material and take any suitable shape. Further, the frame 102 can have any suitable dimensions. In one or more embodiments, the frame 102 can have a length that is greater than a length of the filter 124 such that a portion of the frame that extends beyond the filter can be grasped for installation or removal without contacting the filter.

The frame 102 can be attached to any suitable filter 124. For example, the frame 102 can be attached to an open cell material and define an outer boundary or surface of the filter for interfacing and seating in a microphone port (e.g., microphone port 14 of FIG. 2). The frame 102 can provide a consistent and predictable interface for the filter 124. In one or more embodiments, the frame 102 can include the same open cell material as the open cell material of the filter 124.

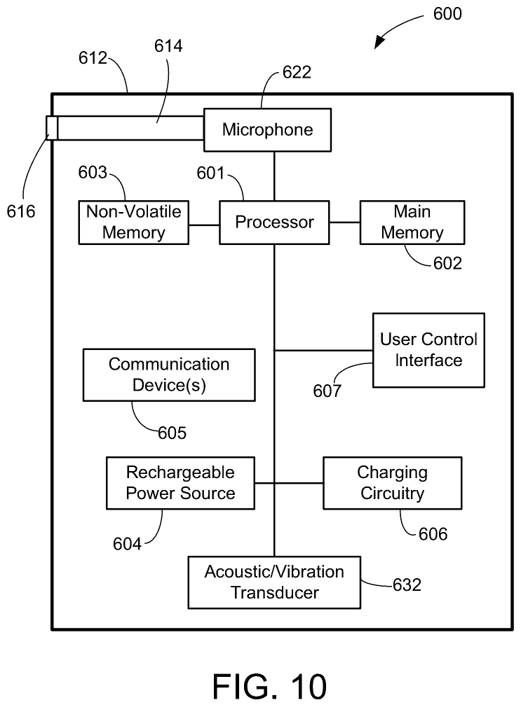

As mentioned herein, the device 10 can include the earpiece 26 (FIGS. 1 and 4) that is coupled to the housing 12 by the cable 28. The earpiece 26 can include the earpiece housing 30 and the receiver 32 disposed at least partially within the housing. The receiver 32 is configured to direct sound waves into the ear of the wearer through the acoustic port 34 that extends between the outlet 36 at the outer surface 38 of the earpiece housing 30 and the inlet 40 disposed within the earpiece housing that is acoustically coupled to the receiver. The receiver 32 can include any suitable receiver or receivers. In one or more embodiments, signals from the microphone 22 can be received by a processor (e.g., processor 601 of ear-wearable device 600 of FIG. 10). The processor can use any suitable technique to produce one or more receiver signals that are based upon the microphone signals and direct such receiver signals to the receiver 32 via the cable 28, where the receiver is configured to receive the receiver signals and reproduce sound into the ear canal of the wearer based upon the receiver signals using any suitable technique.

In one or more embodiments, the filter 24 can be considered a first filter, and the device 10 can include a second filter 62 that is disposed over the outlet 36 of the acoustic port 34 of the earpiece 26 or at least partially within the acoustic port. The second filter 62 can include any suitable filter, e.g., filter 24. In one or more embodiments, the second filter 62 includes an open cell material. In one or more embodiments, the device 10 includes the second filter 62 disposed over the outlet 36 or at least partially within the acoustic port 34 and no filter 24 disposed over the inlet 16 of the microphone port 14 or at least partially within the microphone port.

In one or more embodiments, the ear-wearable device 10 can include one or more wearer input devices 46. In the example of FIG. 1, the wearer input devices 46 are disposed on the top shell 42 of the housing 12, but other placements of the wearer input devices are possible. The wearer input devices 46 may include buttons, switches, or the like, such as a first button and a second button. The wearer can interact with the wearer input devices 46 (e.g., by pressing one or more buttons) to, e.g., adjust the volume, change one or more settings, or turn the ear-wearable device on or off.

In one or more embodiments, the device 10 can include a third filter 64 disposed over an inlet 68 of a microphone port 66 of a second microphone 70 that is disposed at least partially within the earpiece housing 30. The second microphone 70 can include any suitable microphone, e.g., microphone 22, and can be acoustically coupled to an outlet 72 of the microphone port 66. Further, the third filter 64 can be disposed at least partially within the microphone port 66, or over the inlet 68 and at least partially within the microphone port. The third filter 64 can include any suitable filter, e.g., filter 24.

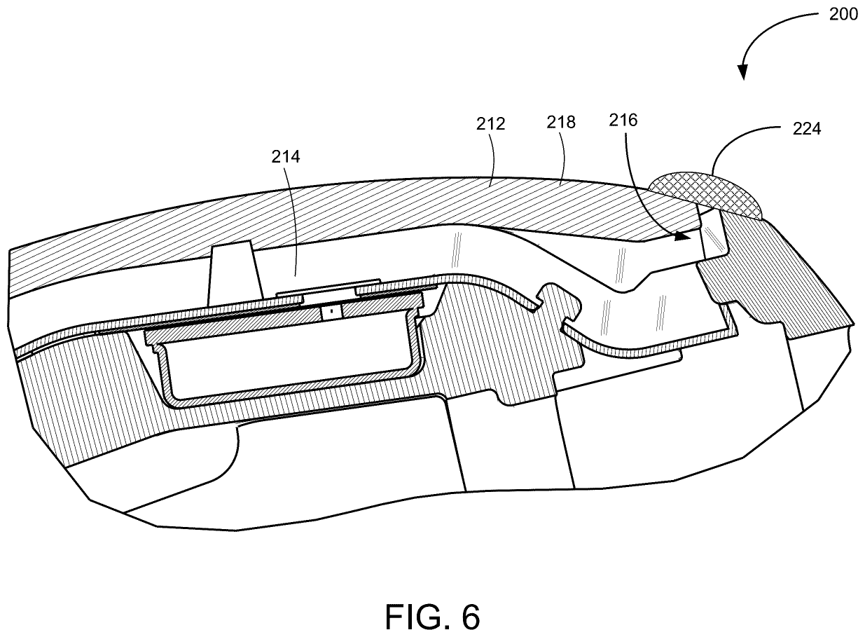

As mentioned herein, the filter 24 can be disposed over the inlet 16. For example, FIG. 6 is a schematic cross-section view of another embodiment of an ear-wearable device 200. All design considerations and possibilities described herein regarding the ear-wearable device 10 of FIGS. 1-4 apply equally to the ear-wearable device 200 of FIG. 6. As shown in the figure, a filter 224 is disposed over an inlet 216 of a microphone port 214 of the device 200. The filter 224 can include any suitable filter described herein, e.g., filter 24 of FIGS. 1-4. In one or more embodiments, the filter 224 can include an open cell material. The filter 224 can be disposed on an outer surface 218 of housing 212 in any suitable location such that it is disposed over the inlet 216 of the microphone port 214. Further, the filter 224 can be connected to the outer surface 218 of the housing 212 using any suitable technique. In one or more embodiments, the filter 224 can be adhered to the outer surface 218 of the housing 212 using any suitable adhesive.

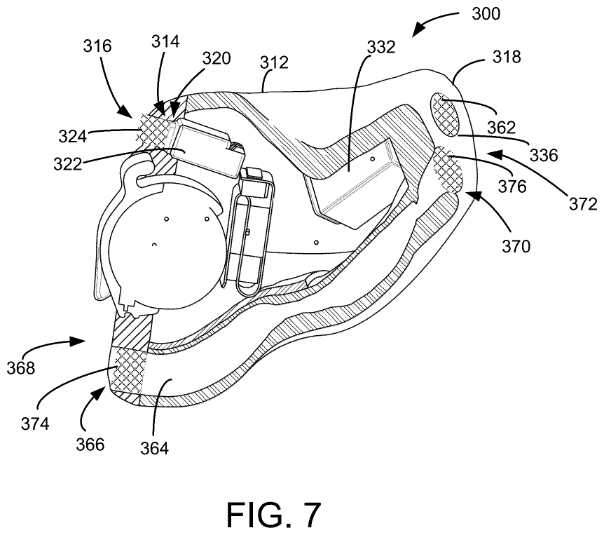

The various embodiments of ear-wearable devices described herein can be any suitable type of wearable or device. In one or more embodiments, the ear-wearable device can be configured to be disposed at least partially within an ear canal of a wearer. For example, FIG. 7 is a schematic cross-section view of another embodiment of an ear-wearable device 300. All design considerations and possibilities described herein regarding the ear-wearable device 10 of FIGS. 1-4 and the ear-wearable device 200 of FIG. 6 apply equally to the ear-wearable device 300 of FIG. 7. The device 300 is configured to be disposed at least partially within an ear canal of a wearer. For example, the device 300 can be a completely-in-canal (CIC) ear-wearable device.

The device 300 includes a housing 312 and a microphone port 314 disposed in the housing and extending between an inlet 316 disposed at an outer surface 318 of the housing and an outlet 320 disposed within the housing. The device 300 further includes a microphone 322 disposed at least partially within the housing 312 and acoustically coupled to the outlet 320 of the microphone port 314. Additionally, the device 300 includes a filter 324 disposed at least partially within the microphone port 314. Although the filter 324 is disposed at least partially within the microphone port 314, in one or more embodiments, the filter 324 can be disposed over the inlet 316 of the microphone port. In one or more embodiments, the filter 324 can be disposed over the inlet 316 of the microphone port 314 and at least partially within the port.

The device 300 also includes a receiver 332 disposed at least partially within the housing 312. The receiver 332 is configured to direct sound waves to the ear canal through an acoustic port (not shown) that extends between an outlet 336 disposed at the outer surface 318 of the housing 312 and an inlet (not shown) disposed within the housing that is acoustically coupled to the receiver 332. As is also shown in FIG. 7, the device 300 includes a second filter 362 disposed over the outlet 336 of the acoustic port or at least partially within the acoustic port. The second filter 362 can include any suitable filter, e.g., filter 24 of FIGS. 1-4.

The device 300 can also include a vent 364 that extends through the housing 312 between an inlet 366 at the outer surface 318 of the housing 12 at a first end 368 of the housing, and an outlet 370 disposed at the outer surface of the housing at a second end 372 of the housing. A vent filter 374 can be disposed over the inlet 366 of the vent 364 or at least partially within the vent. The vent filter 374 can include any suitable filter, e.g., filter 24 of FIGS. 1-4. Further, in one or more embodiments, the device 300 can also include a second vent filter 376 disposed over the outlet 370 of the vent 364 or at least partially within the vent. The second vent filter 376 can include any suitable filter, e.g., filter 24 of FIGS. 1-4. The first and second vent filters 374, 376 can each include any suitable material, e.g., an open cell material.

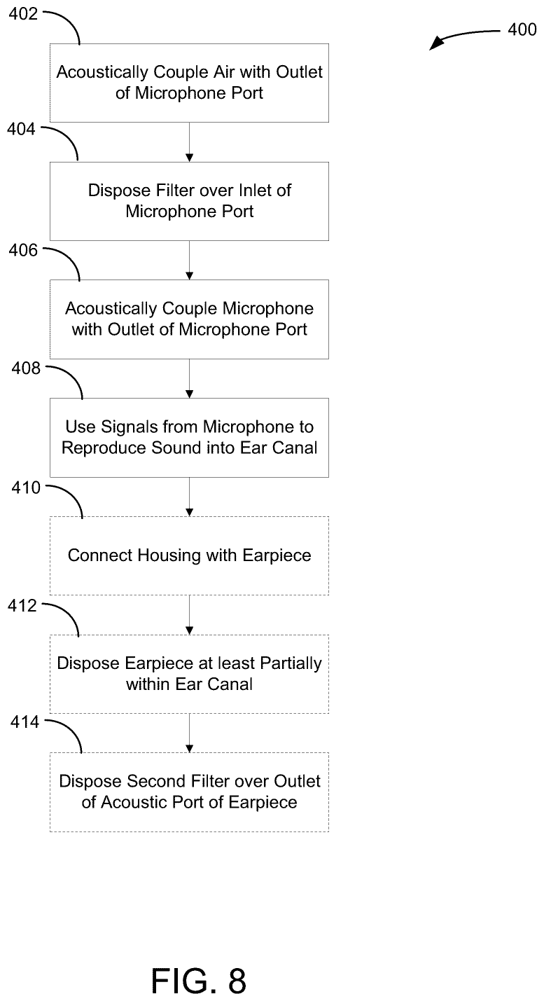

Any suitable technique can be utilized with the various embodiments of filters described herein such that they are connected to or associated with one or more ports of the device 10. For example, FIG. 8 is a flowchart of one embodiment of a method 400. Although the method is described regarding the ear-wearable device 10 of FIG. 1-4, the method can be utilized with any suitable device. At 402, air outside of the housing 12 of the ear-wearable device 10 can be acoustically coupled with the outlet 20 of the microphone port 14 within the housing via inlet 16 of the port using any suitable technique. At 404, the filter 24 can be disposed over the inlet 16 of the microphone port 14 or at least partially within the microphone port using any suitable technique, e.g., adhering, friction fitting, mechanically fastening, etc. The filter 24 can include any suitable filter that includes any suitable material, e.g., an open cell material. The microphone 22 can be acoustically coupled with the outlet 20 of the microphone port 14 at 406 using any suitable technique. Further, at 408, signals from the microphone 22 can be utilized to reproduce sound into the ear canal of the wearer of the device 10 using any suitable technique. In one or more embodiments, the filter 24 can be configured to attenuate wind noise that is directed to the inlet 16 of the microphone port 14 and is incident upon the filter.

At 410, if the device 10 is a BTE device, then the housing 12 of the device can optionally be connected with the earpiece 26 utilizing the cable 28. At 412, the earpiece 26 can optionally be disposed at least partially within the ear canal of the wearer. The sound can be reproduced into the ear canal by the receiver 32 that is disposed at least partially within the earpiece 26. Further, at 414, the second filter 62 can optionally be disposed over the outlet 36 of the acoustic port 34 of the earpiece 26 or at least partially within the acoustic port using any suitable technique. The second filter 62 can include any suitable filter, e.g., filter 24, and can also include any suitable material. In one or more embodiments, the second filter 62 includes an open cell material. In one or more embodiments, at least one of the filter 24 of the second filter 62 is configured to at least partially block ingress of debris (e.g., wax) into the microphone port 14 or the acoustic port 34.

The various embodiments of ear-wearable devices described herein can include any suitable electronic components or circuitry. For example, FIG. 10 is a block diagram that illustrates one embodiment of a system and ear-wearable device 600 in accordance with any of the embodiments disclosed herein. The device 600 includes a housing 612 configured to be worn in, on, or about an ear of a wearer. The hearing device 600 shown in FIG. 10 can represent a single hearing device configured for monaural or single-ear operation or one of a pair of hearing devices configured for binaural or dual-ear operation. Various components are situated or supported within or on the housing 612. The housing 612 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The hearing device 600 includes a processor 601 operatively coupled to a main memory 602 and a non-volatile memory 603. The processor 601 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 601 can include or be operatively coupled to main memory 602, such as RAM (e.g., DRAM, SRAM). The processor 601 can include or be operatively coupled to non-volatile (persistent) memory 603, such as ROM, EPROM, EEPROM or flash memory.

The hearing device 600 includes an audio processing facility operably coupled to, or incorporating, the processor 601. The audio processing facility includes audio signal processing circuitry (e.g., analog front-end, analog-to-digital converter, digital-to-analog converter, DSP, and various analog and digital filters), a microphone arrangement 622, and an acoustic/vibration transducer 632 (e.g., loudspeaker, receiver, bone conduction transducer, motor actuator). The acoustic transducer 632 produces amplified sound inside of the ear canal. The microphone arrangement 622 can include one or more discrete microphones or a microphone array(s) (e.g., configured for microphone array beamforming). Each of the microphones of the microphone arrangement 622 can be situated at different locations of the housing 612. It is understood that the term microphone used herein can refer to a single microphone or multiple microphones unless specified otherwise. The microphone 322 is operatively coupled to the processor 601 and is configured to direct a microphone signal to the processor, which in turn directs a receiver signal to the transducer 632 that is based at least in part on the microphone signal.

At least one of the microphones 622 may be configured as a reference microphone producing a reference signal in response to external sound outside an ear canal of a user. Generally, at least one the reference microphones 622 (also referred to as an externally facing microphones) is acoustically coupled to ambient air outside the housing 612 via an acoustic pathway or microphone port 614 and a microphone inlet 616. The microphone inlet 616 allows air to pass between two parts of the housing 612 or may be formed within one part of the housing.

The hearing device 600 may also include a user control interface 607 operatively coupled to the processor 601. The user control interface 607 is configured to receive an input from the wearer of the hearing device 600. The input from the wearer can be any type of user input, such as a touch input, a gesture input, or a voice input. The user control interface 607 may be configured to receive an input from the wearer of the hearing device 600.

The hearing device 600 can include one or more communication devices 605. For example, the one or more communication devices 605 can include one or more radios coupled to one or more antenna arrangements that conform to an IEEE 802.13 (e.g., Wi-Fi®) or Bluetooth® (e.g., BLE, Bluetooth® 4.2, 5.0, 5.1, 5.2 or later) specification, for example. In addition, or alternatively, the hearing device 600 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 605 may also include wired communications, e.g., universal serial bus (USB) and the like.

The hearing device 600 also includes a power source, which can be a conventional battery, a rechargeable battery (e.g., a lithium-ion battery), or a power source including a supercapacitor. In the embodiment shown in FIG. 10, the hearing device 600 includes a rechargeable power source 604 that is operably coupled to power management circuitry for supplying power to various components of the hearing device 600. The rechargeable power source 604 is coupled to charging circuitry 606. The charging circuitry 606 is, for example, electrically coupled to charging contacts on the housing 612 that are configured to electrically couple to corresponding charging contacts of a charging unit when the hearing device 600 is placed in the charging unit.

Embodiments of the disclosure are defined in the claims; however, herein there is provided a non-exhaustive listing of non-limiting examples. Any one or more of the features of these examples may be combined with any one or more features of another example, embodiment, or aspect described herein.

Example Ex1. An ear-wearable device including a housing, a microphone port disposed in the housing and extending between an inlet disposed at an outer surface of the housing and an outlet disposed within the housing, and a microphone disposed within the housing and acoustically coupled to the outlet of the microphone port. The device further includes a filter disposed over the inlet of the microphone port or at least partially within the microphone port, where the filter includes an open cell material.

Example Ex2. The device of Ex1, where the filter is configured to reduce wind noise received by the microphone through the microphone port.

Example Ex3. The device of any one of Ex1-Ex2, where the filter is configured to at least partially block ingress of debris into the microphone port.

Example Ex4. The device of any one of Ex1-Ex3, where the filter further includes a frame connected to the open cell material.

Example Ex5. The device of any one of Ex1-Ex4, where the open cell material includes a foam.

Example Ex6. The device of any one of Ex1-Ex5, where the open cell material includes melamine.

Example Ex7. The device of any one of Ex1-Ex5, where the open cell material includes polyurethane.

Example Ex8. The device of any one of Ex1-Ex7, where the open cell material includes an average pore diameter of no greater than 200 microns.

Example Ex9. The device of any one of Ex1-Ex8, where the open cell material includes a porosity of at least 90%.

Example Ex10. The device of Ex9, where the open cell material includes a porosity of no greater than 99%.

Example Ex11. The device of any one of Ex1-Ex10, where the filter is friction-fit at least partially within the microphone port.

Example Ex12. The device of any one of Ex1-Ex11, where the filter is adhered to the outer surface of the housing.

Example Ex13. The device of Ex12, where the filter forms a portion of the housing.

Example Ex14. The device of any one of Ex1-Ex13, where the filter further includes a hydrophobic material.

Example Ex15. The device of any one of Ex1-Ex14, where the filter further includes an oleophobic material.

Example Ex16. The device of any one of Ex1-Ex15, where the filter is configured to attenuate sound waves received into the microphone port by no greater than 4 dB SPL.

Example Ex17. The device of any one of Ex1-Ex16, further including an earpiece that is coupled to the housing by a cable, where the earpiece includes an earpiece housing and a receiver disposed at least partially within the housing. The receiver is configured to direct sound waves into a wearer's ear through an acoustic port that extends between an outlet disposed at an outer surface of the earpiece housing and an inlet disposed within the earpiece housing that is acoustically coupled to the receiver.

Example Ex18. The device of Ex17, further including a second filter disposed over the outlet of the acoustic port or at least partially within the acoustic port, where the second filter includes an open cell material.

Example Ex19. The device of any one of Ex1-Ex16, where the ear-wearable device is configured to be disposed at least partially within an ear canal of a wearer.

Example Ex20. The device of claim 19, where the ear-wearable device further includes a receiver disposed at least partially within the housing, where the receiver is configured to direct sound waves to the ear canal through an acoustic port that extends between an outlet disposed at the outer surface of the housing and an inlet disposed within the housing and acoustically coupled to the receiver; and a second filter disposed over the outlet of the acoustic port or at least partially within the acoustic port, where the second filter includes an open cell material.

Example Ex21. The device of any one of Ex19-Ex20, where the housing further includes a vent that extends through the housing between an inlet disposed at the outer surface of the housing at a first end of the housing and an outlet disposed at the outer surface of the housing at a second end of the housing. The device further includes a vent filter disposed over the inlet of the vent or at least partially within the vent, where the filter includes an open cell material.

Example Ex22. A method including acoustically coupling, via an inlet of a microphone port, air outside of a housing of an ear-wearable device with an outlet of the microphone port within the housing; disposing a filter over the inlet of the microphone port or at least partially within the microphone port, where the filter includes an open cell material; and acoustically coupling a microphone with the outlet of the microphone port. The method further includes using signals from the microphone to reproduce sound into an ear canal of a wearer of the ear-wearable device.

Example Ex23. The method of Ex22, further connecting the housing with an earpiece utilizing a cable, and disposing the earpiece at least partially within the ear canal of the wearer. The sound is reproduced into the ear canal by a receiver disposed at least partially within the earpiece.

Example Ex24. The method of Ex23, further including disposing a second filter over an outlet of an acoustic port of the earpiece or at least partially within the acoustic port, where the second filter includes an open cell material, and where the acoustic port extends between the outlet that is disposed at an outer surface of a housing of the earpiece and an inlet disposed within the housing of the earpiece. The inlet is acoustically coupled to the receiver.

Example Ex25. The method of Ex24, where at least one of the filter or the second filter is configured to at least partially block ingress of debris into the microphone port or the acoustic port.

Example Ex26. The method of any one of Ex24-Ex25, where at least one of the filter or second filter includes a frame connected to the open cell material.

Example Ex27. The method of any one of Ex24-Ex26, where the open cell material of at least one of the filter or second filter includes a foam.

Example Ex28. An ear-wearable device including a housing, a receiver disposed at least partially within the housing and configured to direct sound waves into a wearer's ear through an acoustic port that extends between an outlet disposed on an outer surface of the housing and an inlet disposed within the housing that is acoustically coupled to the receiver, and a filter disposed over the outlet of the acoustic port or at least partially within the acoustic port, where the filter includes an open cell material.

Example Ex29. The device of Ex28, further including a microphone port disposed in the housing and extending between an inlet disposed at the outer surface of the housing and an outlet disposed within the housing; and a microphone disposed within the housing and acoustically coupled to the outlet of the microphone port. The microphone is configured to direct a microphone signal to a processor.

Example Ex30. The device of Ex29, where the filter is a second filter, and where the device further includes a first filter that is disposed over the inlet of the microphone port or at least partially within the microphone port. The first filter includes an open cell material.

Example Ex31. The device of Ex30, where the second filter is configured to at least partially block ingress of debris into the acoustic port.

Example Ex32. The device of any one of Ex30-Ex31, where at least one of the first filter or second filter further includes a frame connected to the open cell material.

Example Ex33. The device of any one of Ex30-Ex32, where the open cell material of at least one of the first filter or second filter includes a foam.

Example Ex34. The device of any one of Ex30-Ex33, where the open cell material of at least one of the first filter or second filter includes melamine.

Example Ex35. The device of any one of Ex30-Ex33, where the open cell material of at least one of the first filter or second filter includes polyurethane.

Example Ex36. The device of any one of Ex30-Ex35, where the open cell material of at least one of the first filter or second filter includes an average pore diameter of no greater than 200 microns.

Example Ex37. The device of any one of Ex30-Ex36, where at least one of the first filter or second filter includes a porosity of at least 90%.

Example Ex38. The device of Ex37, where at least one of the first filter or second filter includes a porosity of at least 99%.

Example Ex39. The device of any one of Ex30-Ex38, where at least one of the first filter or second filter is friction-fit at least partially within the acoustic port.

Example Ex40. The device of any one of Ex30-Ex39, where at least one of the first filter or second filter is adhered to the outer surface of the housing.

Example Ex41. The device of Ex40, where at least one of the first filter or second filter forms a portion of the housing.

Example Ex42. The device of any one of Ex30-Ex41, where at least one of the first filter or second filter further includes a hydrophobic material.

Example Ex43. The device of any one of Ex30-Ex42, where at least one of the first filter or second filter further includes an oleophobic material.

Example Ex44. The device of any one of Ex30-Ex43, where the first filter is configured to attenuate sound waves received into the microphone port by no greater than 4 dB SPL.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An ear-wearable device comprising:
a housing;
a microphone port disposed in the housing and extending between an inlet disposed at an outer surface of the housing and an outlet disposed within the housing;
a microphone disposed within the housing and acoustically coupled to the outlet of the microphone port; and
a filter disposed over the inlet of the microphone port or at least partially within the microphone port, wherein the filter comprises an open cell material.

2. The device of claim 1, wherein the filter is configured to reduce wind noise received by the microphone through the microphone port.

3. The device of claim 1, wherein the filter is configured to at least partially block ingress of debris into the microphone port.

4. The device of claim 1, wherein the filter further comprises a frame connected to the open cell material.

5. The device of claim 1, wherein the open cell material comprises a foam.

6. The device of claim 1, wherein the open cell material comprises an average pore diameter of no greater than 200 microns.

7. The device of claim 1, wherein the open cell material comprises a porosity of at least 90%.

8. The device of claim 1, wherein the filter further comprises at least one of a hydrophobic material or an oleophobic material.

9. The device of claim 1, wherein the filter is configured to attenuate sound waves received into the microphone port by no greater than 4 dB SPL.

10. The device of claim 1, further comprising:
an earpiece that is coupled to the housing by a cable, wherein the earpiece comprises an earpiece housing and a receiver disposed at least partially within the housing, wherein the receiver is configured to direct sound waves into a wearer's ear through an acoustic port that extends between an outlet disposed at an outer surface of the earpiece housing and an inlet disposed within the earpiece housing that is acoustically coupled to the receiver; and
a second filter disposed over the outlet of the acoustic port or at least partially within the acoustic port, wherein the second filter comprises an open cell material.

11. The device of claim 1, wherein the ear-wearable device is configured to be disposed at least partially within an ear canal of a wearer, wherein the ear-wearable device further comprises:
a receiver disposed at least partially within the housing, wherein the receiver is configured to direct sound waves to the ear canal through an acoustic port that extends between an outlet disposed at the outer surface of the housing and an inlet disposed within the housing and acoustically coupled to the receiver; and
a second filter disposed over the outlet of the acoustic port or at least partially within the acoustic port, wherein the second filter comprises an open cell material.

12. The device of claim 1, wherein the open cell material of the filter defines an irregular internal structure of the filter, wherein the irregular internal structure is predefined.

13. A method comprising:
acoustically coupling, via an inlet of a microphone port, air outside of a housing of an ear-wearable device with an outlet of the microphone port within the housing;
disposing a filter over the inlet of the microphone port or at least partially within the microphone port, wherein the filter comprises an open cell material;
acoustically coupling a microphone with the outlet of the microphone port; and
using signals from the microphone to reproduce sound into an ear canal of a wearer of the ear-wearable device.

14. The method of claim 13, further comprising:
connecting the housing with an earpiece utilizing a cable;
disposing the earpiece at least partially within the ear canal of the wearer, wherein the sound is reproduced into the ear canal by a receiver disposed at least partially within the earpiece; and
disposing a second filter over an outlet of an acoustic port of the earpiece or at least partially within the acoustic port, wherein the second filter comprises an open cell material, wherein the acoustic port extends between the outlet that is disposed at an outer surface of a housing of the earpiece and an inlet disposed within the housing of the earpiece, wherein the inlet is acoustically coupled to the receiver.

15. An ear-wearable device comprising:
a housing;
a receiver disposed at least partially within the housing and configured to direct sound waves into a wearer's ear through an acoustic port that extends between an outlet disposed at an outer surface of the housing and an inlet disposed within the housing that is acoustically coupled to the receiver; and
a filter disposed over the outlet of the acoustic port or at least partially within the acoustic port, wherein the filter comprises an open cell material.

16. The device of claim 15, wherein the open cell material of the filter comprises a foam.

17. The device of claim 15, wherein the filter comprises a porosity of at least 90%.

18. The device of claim 15, wherein the filter is friction-fit at least partially within the acoustic port.

19. The device of claim 15, wherein the filter further comprises at least one of a hydrophobic material or an olcophobic material.

20. The device of claim 15, wherein the filter is configured to attenuate sound waves received into the microphone port by no greater than 4 dB SPL.
